(19) United States
(12) Patent Application Publication
(10) Pub. No.: US 2019/0270362 A1
(43) Pub. Date: Sep. 5, 2019

(54) NOISE-DAMPENING PRESSURE RELIEF ASSEMBLY

(71) Applicant: ILLINOIS TOOL WORKS INC., Glenview, IL (US)

(72) Inventors: Timothy M. Barnes, Leominster, MA (US); James Francis Fleck, Warren, MI (US); Tyler M. Letherwood, Plymouth, MI (US); Michael Raymond Markie, Roseville, IL (US); John Elmer Carey, Ortonville, MI (US)

(21) Appl. No.: 16/344,278

(22) PCT Filed: Oct. 4, 2017
(86) PCT No.: PCT/US2017/055083

§ 371 Date: Apr. 23, 2019

Related U.S. Application Data
(60) Provisional application No. 62/419,716, filed on Nov. 9, 2016.

(51) Int. Cl. B60H 1/24; F16K 15/03; F16K 27/02; F16K 17/02

(52) U.S. Cl. CPC B60H 1/249; F16K 17/02; F16K 27/0227; F16K 15/031

(57) ABSTRACT

A pressure relief assembly (100) includes a housing (102) including an air passage chamber (104) having a flap barrier (122) surrounding at least one airflow passage. A membrane flap is secured within the air passage chamber. The membrane flap covers the airflow passage(s) in a closed position. A portion of the membrane flap is configured to move off the airflow passage(s) into an open position. A noise-dampening seal (120) formed of a noise-dampening material is proximate to at least a portion of the flap barrier. The noise-dampening seal is configured to reduce noise generated by movement of the membrane flap as the membrane flap moves from the open position to the closed position. The noise-dampening seal provides a sealing interface with the membrane flap in the closed position.

### RELATED APPLICATIONS

This application relates to and claims priority benefits from U.S. Provisional Patent Application No. 62/419,716, entitled “Pressure Relief Assembly Having Flap-Engaging Seal,” filed Nov. 9, 2016, which is hereby incorporated by reference in its entirety.

### FIELD OF EMBODIMENTS OF THE DISCLOSURE

Embodiments of the present disclosure generally relate to a venting or pressure relief device configured for use in an enclosed area, such as an automobile, and more particularly to systems and methods for reducing noise that may be generated by a pressure relief assembly.

### BACKGROUND

Interior cabins of vehicles typically include cabin vents or pressure relief devices. Without such devices, air pressure inside the vehicle cabin could damage occupants' ear drums. Further, when a vehicle door is closed, air pressure within the vehicle needs to be relieved or the door will not close. If an air bag is activated in a vehicle that does not have a venting or pressure relief device, an occupant's ear drums may be damaged.

Pressure relief devices are usually hidden from view. For example, a pressure relief device may be found in a trunk or on a body frame pillar structure. Each pressure relief device is adapted to allow air to pass out of an enclosed structure, while also preventing a significant amount of air, dust, water or other contaminants into the enclosed area. Thus, pressure relief devices are, in essence, one-way valves or one-way check valves, and are configured to maintain a small amount of back pressure per customer specifications.

A conventional pressure relief device includes a plastic housing having a plurality of air passages. A light membrane is positioned over the air passages, and is configured to allow air to pass in one direction. In order to allow air to pass, the light membrane opens off of the main body in response to air flow. Typically, a seal is provided around the main body and acts to seal the hole in the mating structure upon assembly. The seal is typically molded around the main body in a secondary molding operation, or may be adhesively or chemically attached to the main body.

During installation, the pressure relief device may be snap fit to a structure. Typically, a user presses on the four corners of the pressure relief device in order to secure it within a reciprocal hole in a structure, such as a frame or sheet within a vehicle.

Pressure relief valves are shown and described in, for example, EP 2050600, U.S. Pat. Nos. 5,105,849, 5,759,097, 5,727,999, 5,904,618, and EP 1985480.

Many known pressure relief valves generate noise when membrane flaps return to their at-rest positions within air passage chambers of housings. For example, as the membrane flaps move back to at-rest positions and abut into a rim or lip surrounding an air passage(s), the contact therebetween may generate undesirable noise. Typically, the rim or lip surrounding the air passage(s) is formed of a hard plastic, along with the rest of the housing. As such, when the membrane flap returns to a hard stop on the rim, a noticeable sound may be generated. In order to reduce such noise, some known pressure relief valves include felt flaps. However, such flaps may not provide desired response to exerted air pressure, as they may be heavier and/or less flexible than typical membrane flaps, for example.

### SUMMARY OF EMBODIMENTS OF THE DISCLOSURE

A need exists for a pressure relief assembly that minimizes or otherwise reduces undesired noise that may be generated by membrane flap motion.

With that need in mind, certain embodiments of the present disclosure provide a pressure relief assembly that includes a housing including an air passage chamber having a flap barrier surrounding at least one airflow passage. A membrane flap is secured within the air passage chamber. The membrane flap covers the airflow passage in a closed position. A portion of the membrane flap is configured to move off the airflow passage into an open position. A noise-dampening seal formed of a noise-dampening material is proximate to at least a portion of the flap barrier. The noise-dampening seal is configured to reduce noise generated by movement of the membrane flap as the membrane flap moves from the open position to the closed position. The noise-dampening seal provides a sealing interface with the membrane flap in the closed position.

The housing may be formed of a material that is harder than the noise-dampening material. In at least one embodiment, the housing is formed of a material that is harder than the noise-dampening material, and at least a portion of the housing is covered with the noise-dampening material.

In at least one other embodiment, the housing is also formed of the noise-dampening material. For example, the housing and the noise-dampening seal may be integrally molded and formed as a single piece of the noise-dampening material.

In at least one embodiment, the noise-dampening seal is secured on and around the portion(s) of the flap barrier. For example, the noise-dampening seal may be secured below and around lateral portions of the flap barrier. In at least one embodiment, the noise-dampening seal is secured on and around an entirety of the flap barrier.

The noise-dampening material may include one or more of rubber, a thermoplastic elastomer, or a thermoplastic vulcanizate. As another example, the noise-dampening material may include a polyurethane foam.

The housing may also include upstanding ribs formed of the noise-dampening material. The upstanding ribs may extend outwardly from a top wall proximate to a pivot location of the membrane flap towards a front outer flange of the housing. The ribs may be configured to prevent the membrane flap from flapping into a backing wall and the outer flange of the housing.

In at least one embodiment, the noise-dampening seal includes the noise-dampening material within a retaining track proximate to the flap barrier. In at least one other embodiment, the pressure relief assembly also includes a retaining track that retains an additional noise-dampening material proximate to the flap barrier in addition to the noise-dampening seal.

### BRIEF DESCRIPTION OF SEVERAL VIEWS OF THE DRAWINGS

FIG. 1 illustrates a front view of a pressure relief assembly, according to an embodiment of the present disclosure.

FIG. 2 illustrates a perspective top view of a pressure relief assembly, according to an embodiment of the present disclosure.

FIG. 3 illustrates a perspective front view of a housing of a pressure relief assembly, according to an embodiment of the present disclosure.

FIG. 4 illustrates a perspective front view of a pressure relief assembly having membrane flaps in closed positions, according to an embodiment of the present disclosure.

FIG. 5 illustrates a perspective front view of a pressure relief assembly having membrane flaps in open positions, according to an embodiment of the present disclosure.

FIG. 6 illustrates a front view of a portion of a housing of a pressure relief assembly, according to an embodiment of the present disclosure.

FIG. 7 illustrates a cross-sectional view of a portion of a housing of a pressure relief assembly through line 7-7 of FIG. 6, according to an embodiment of the present disclosure.

FIG. 8 illustrates a front view of a portion of a housing of a pressure relief assembly having a noise-dampening fixture, according to an embodiment of the present disclosure.

FIG. 9 illustrates a cross-sectional view of a portion of a housing of a pressure relief assembly having a noise-dampening fixture through line 9-9 of FIG. 8, according to an embodiment of the present disclosure.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE DISCLOSURE

Embodiments of the present disclosure provide a pressure relief valve/assembly that includes a main housing defining one or more air passages. Flaps are mounted over the air passages. In at least one embodiment, a noise-dampening seal is secured on and around a portion of a flap barrier such as a rim, lip, or edge surrounding the air passages. The seal may extend over a lower edge, and may extend onto lateral edges of the rim. In at least one embodiment, the seal extends around an entirety of a rim, lip, or edge defining the air passage(s). The seal may be formed of rubber or various other elastomeric materials, for example. In at least one embodiment, the seal may be formed of a thermoplastic elastomer (TPE), a thermoplastic vulcanizate (TPV), such as Santoprene, and/or the like. The seal provides a noise-dampening lip that mitigates (for example, eliminates, minimizes, or otherwise reduces) noise that may otherwise be generated by a flap moving into a hard stop onto a hard plastic rim. At the same time, when the membrane flap is in a closed position, the seal provides a fluid-tight interface with an underside of the flap, thereby preventing or otherwise reducing reverse air-flow and liquid infiltration therethrough.

In at least one embodiment, the seal may be overmolded onto the rim during a forming process of the pressure relief assembly. Accordingly, additional components or assemblies are not required to form the pressure relief assembly.

In at least one embodiment, the housing of the pressure relief valve may be formed of or covered with a noise-dampening material, such as rubber, other elastomeric materials, a TPE, a TPZ, and/or the like, instead of a hard plastic. In this manner, a separate and distinct seal may not be necessary around the lip or rim that defines the air passage chamber(s). Instead, the housing itself provides a noise-dampening structure that also provides a sealing interface with the membrane flaps in the closed position. In at least one embodiment, the lip or rim defining the air passage(s) may be formed of a noise-dampening material, while the remainder of the housing is formed of a hard plastic, for example.

Further, pivot locations for the flaps may be formed of or covered with the noise-dampening material. The noise-dampening material also provides a sealing interface with the flaps.

The housing may also include upstanding ribs, which may also be formed of a noise-dampening material. The ribs provide a stop barrier that prevents the flaps from flapping into a wall of the housing. Because the ribs are made of the noise-dampening material, as the flaps move into the ribs, generated noise is dampened by the ribs.

Embodiments of the present disclosure provide a pressure relief assembly in which interfaces between the membrane flaps and the housing may be formed of a soft plastic material that provides a sealing interface that prevents or otherwise reduces reverse air flow and water infiltration therethrough, while also dampening noise that may be generated by interaction of the membrane flap and the housing. Further, embodiments of the present disclosure provide pressure relief assemblies that allow the flaps to freely pivot, thereby maximizing air flow in an open position (in contrast to other known pressure relief valves that include hinges that limit airflow and slap close, thereby generating a noticeable noise). The pressure relief assembly may include a seal between the flap pivot interface and the housing.

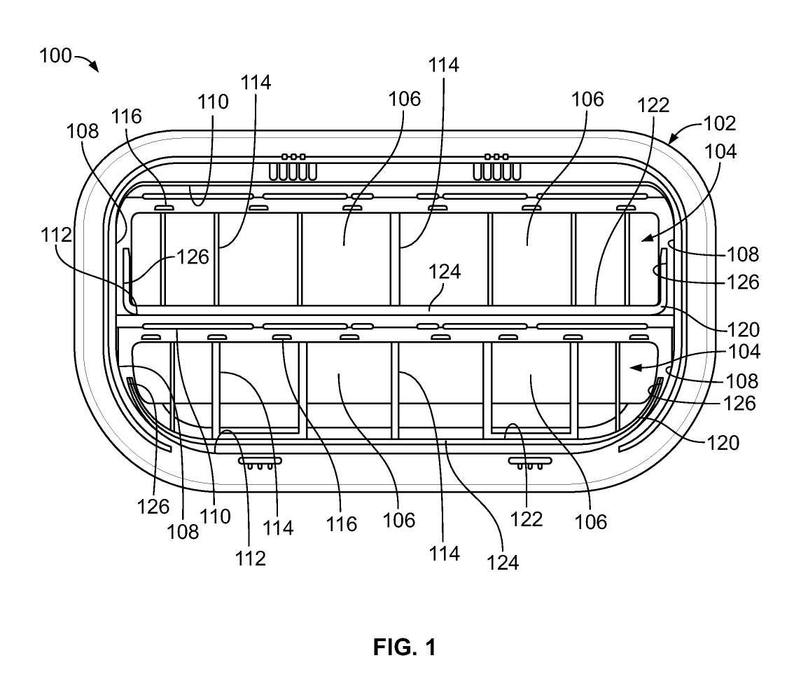

FIG. 1 illustrates a front view of a pressure relief assembly, valve, or device 100, according to an embodiment of the present disclosure. The pressure relief assembly 100 is configured to secure to a component, such as a panel of sheet metal of a vehicle, for example. The pressure relief assembly 100 secures into an opening formed through the panel. For example, the pressure relief assembly 100 may snapably secure into the opening formed through the panel.

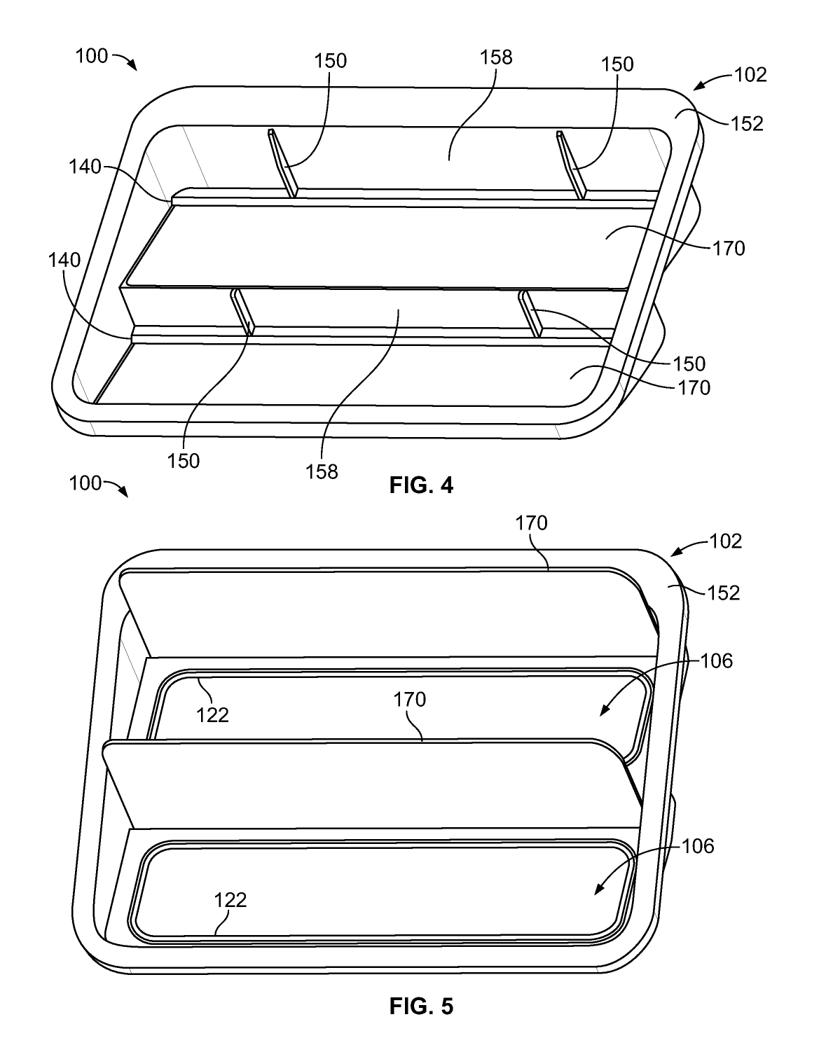

The pressure relief assembly 100 includes a frame or housing 102 that includes a plurality of air passage chambers 104 that define airflow openings 106. Flaps (shown in FIGS. 4 and 5) secure in the air passage chambers 104 over the airflow openings 106. The pressure relief assembly 100 may include more or less air passage chambers 104 and flaps than indicated in FIG. 1.

Each air passage chamber 104 includes lateral walls 108 integrally connected to top and bottom walls 110 and 112, respectively. An air passage wall 114 (which may be partially defined by support ribs) may extend between the lateral, top and bottom walls 108, 110, and 112, respectively. The air passage walls 114 define the airflow openings 106 that are configured to allow air to pass therethrough. The air passage walls 114 may angle upwardly from the top wall 110 towards the bottom wall 112. The angle of the air passage walls 114 may vary based on a desired amount of flap resistive force.

The housing 102 may be formed of a hard plastic, such as acrylic. In at least one embodiment, the housing 102 is formed of injection-molded polypropylene. The housing 102 may be formed through a thermoforming process, which is generally an efficient and economical way of making various plastic devices. During the manufacturing process, a roll of plastic may be fed into a cavity, and then the plastic is formed using heat and pressure.

Instead of a plurality of air passage chambers 104, the housing 102 may include a single air passage chamber 104. Further, each air passage chamber 104 may define more or less airflow openings 106 than shown. For example, an air passage chamber 104 may define a single airflow opening 106. Also, optionally, the air passage wall 114 may be coplanar with a flat underside of the housing 102, instead of being angled.

In closed positions, the flaps cover the air passage walls 114. Each flap may be anchored to the housing 102 proximate to the top wall 110. For example, the flaps may mount to the housing 102 through first attachments, such as connecting protuberances 116 outwardly extending above the airflow openings 106. Each flap may be a flexible membrane having channels formed proximate to an upper edge. The connecting protuberances 116 extend through the channels to secure the flaps to the housing 102. The flaps may be formed of a flexible thermoplastic elastomer, such as ethylene propylene diene monomer (EPDM) rubber, polypropylene, Hytrel, Lexan, Tyvac or Mylar, for example.

In at-rest positions, the flaps cover the airflow openings 106. As air pressure builds and is exerted into undersides of the flaps, the flaps pivot or otherwise flap open so that the airflow openings 106 are exposed, thereby allowing air to vent through the pressure relief assembly 100.

A noise-dampening seal 120 is secured on and around a portion of a flap barrier 122 (such as a rim, lip, or edge) surrounding at least a portion of the air passage chambers 104. As shown, the noise-dampening seals 120 may be secured over the flap barrier 122 below and around lateral portions of the air passage chambers 104. In particular, the noise-dampening seals 120 may extend over a lower edge 124, and may extend upwardly onto lateral edges 126 of the flap barrier 122. Optionally, the noise-dampening seal 120 may extend around more or less of the flap barrier 122 than shown. In at least one embodiment, the noise-dampening seal 120 extends around an entirety of flap barrier 122 that defines the air flow openings 106.

The noise-dampening seal 120 may be formed of rubber or various other elastomeric materials, for example. In at least one embodiment, the noise-dampening seal 120 may be formed of a thermoplastic elastomer (TPE), a thermoplastic vulcanizate (TPV), such as Santoprene, and/or the like. The noise-dampening 120 seal provides a noise-dampening lip that mitigates noise that may otherwise be generated by a flap moving into a hard stop onto a hard plastic rim. At the same time, when the membrane flap is in a closed position, the noise-dampening seal 120 provides a fluid-tight interface with an underside of the flap, thereby preventing or otherwise reducing reverse air-flow and liquid infiltration therethrough.

In at least one embodiment, the noise-dampening seal 120 may be overmolded onto the flap barrier 122 during a forming process of the pressure relief assembly 100. As such, additional components or assemblies are not required to form the pressure relief assembly 100.

In at least one embodiment, the housing 102 may also be formed of a noise-dampening material, similar to the noise-dampening seal 120. For example, instead of being formed of a hard plastic, the housing 102 may be formed of rubber or various other elastomeric materials, for example. In at least one embodiment, the housing 102 and the noise-dampening seal 120 may be formed of a thermoplastic elastomer (TPE), a thermoplastic vulcanizate (TPV), such as Santoprene, and/or the like. As an example, the housing 102 and the noise-dampening seal(s) 120 may be integrally molded and formed as a single piece of the noise-dampening material, such as rubber, TPE, TPV, and/or the like.

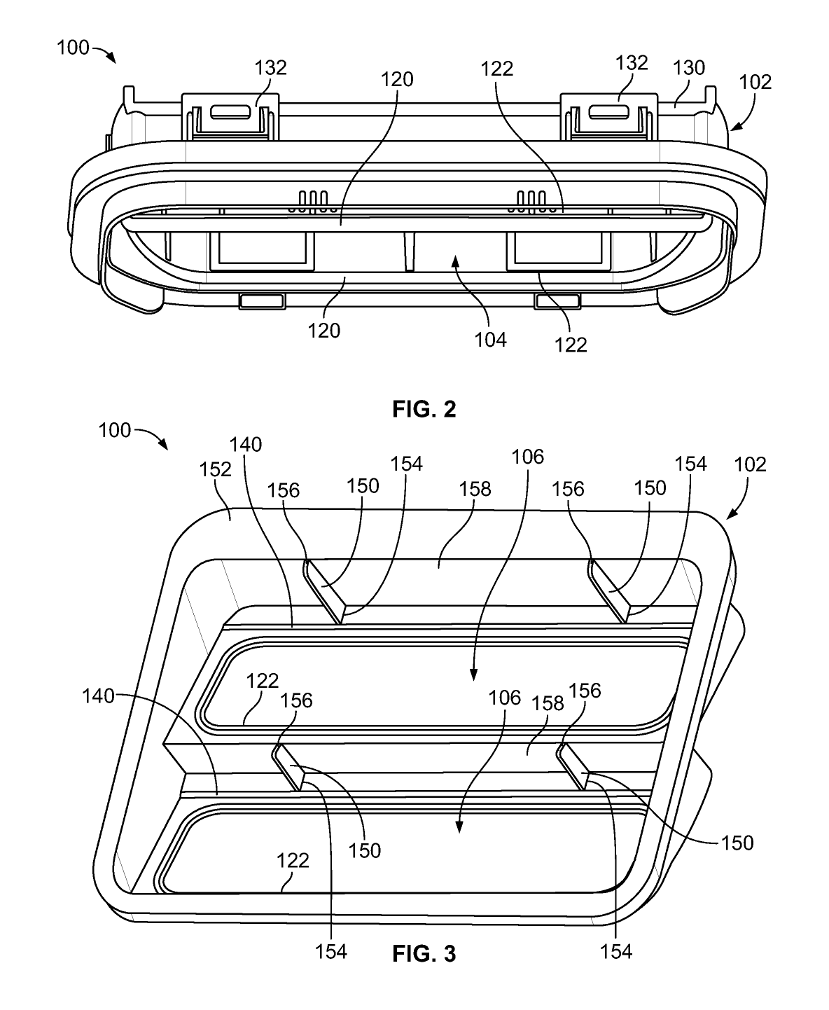

FIG. 2 illustrates a perspective top view of the pressure relief assembly 100. The noise-dampening seals 120 conform to the shape of the flap barrier 122 over which the noise-dampening seals 120 are secured. The housing 102 also includes a rear bracket 130 that is configured to secure into an opening of a panel, such as through one or more clips 132.

FIG. 3 illustrates a perspective front view of the housing 102 of the pressure relief assembly 100, according to an embodiment of the present disclosure. The noise-dampening seal 120 shown described with respect to FIGS. 1 and 2 may also be used with the embodiments shown in FIG. 3.

Referring to FIG. 3, and as noted above with respect to FIGS. 1 and 2, the housing 102 itself may be formed of a noise-dampening material, such as rubber, other elastomeric materials, a TPE, a TPZ, or the like, instead of a plastic. Optionally, the housing 102 may be formed of a plastic (such as acrylic, polypropylene, or the like), and covered with a noise-dampening material, such as rubber, TPE, TPZ, other plastic materials, and/or the like. As such, a separate and distinct seal may not be necessary around the flap barrier 122 that defines the airflow openings 106. Instead, the housing 102 itself (being formed from and/or covered with a noise-dampening material) provides a noise-dampening structure that also provides a sealing interface with the membrane flaps (shown in FIGS. 4 and 5) in the closed position. In at least one other embodiment, the flap barrier 122 surrounding the airflow openings 106 may be formed of and/or covered with a noise-dampening material, while the remainder of the housing 102 is formed of a conventional plastic, for example.

Additionally, pivot locations 140 for the membrane flaps (that is, the areas where the membrane flaps are anchored to the housing 102) may be formed of and/or covered with the noise-dampening material. The noise-dampening material also provides a sealing interface with the flaps. In at least one embodiment, the entirety of the flap barrier 122 that surrounds the airflow opening(s) 106 may be formed of and/or covered with the noise-dampening material.

The housing 102 may also include upstanding ribs 150, which may also be formed of a noise-dampening material. Each rib 150 extends outwardly from a top wall 110 proximate to a pivot location 140 towards a front outer flange 152 of the housing 102. The ribs 150 may include an expanded base 154 proximate to the top wall 110 and a tapered tip 156 proximate to the outer flange 152. The ribs 150 may also connect to an upper backing wall 158 that connects the top wall 110 to the outer flange 152.

FIG. 4 illustrates a perspective front view of the pressure relief assembly 100 having membrane flaps 170 in closed positions, according to an embodiment of the present disclosure. FIG. 5 illustrates a perspective front view of the pressure relief assembly 100 having the membrane flaps 170 in open positions.

Referring to FIGS. 3-5, the ribs 150 provide a stop barrier that prevents the flaps 170 from flapping into the backing walls 158 and/or the outer flange 152 of the housing 102. Because the ribs 150 are made of the noise-dampening material, as the flaps 170 move into the ribs 150, generated noise is dampened by the ribs 150. The ribs 150 may also be used with the embodiments shown and described with respect to FIGS. 1 and 2.

In the at-rest positions shown in FIG. 4, the flaps 170 cover the airflow openings 106. As air pressure builds and is exerted into undersides of the flaps 170, the flaps 170 pivot or otherwise flap open so that the airflow openings 106 are exposed, thereby allowing air to vent through the pressure relief assembly 100.

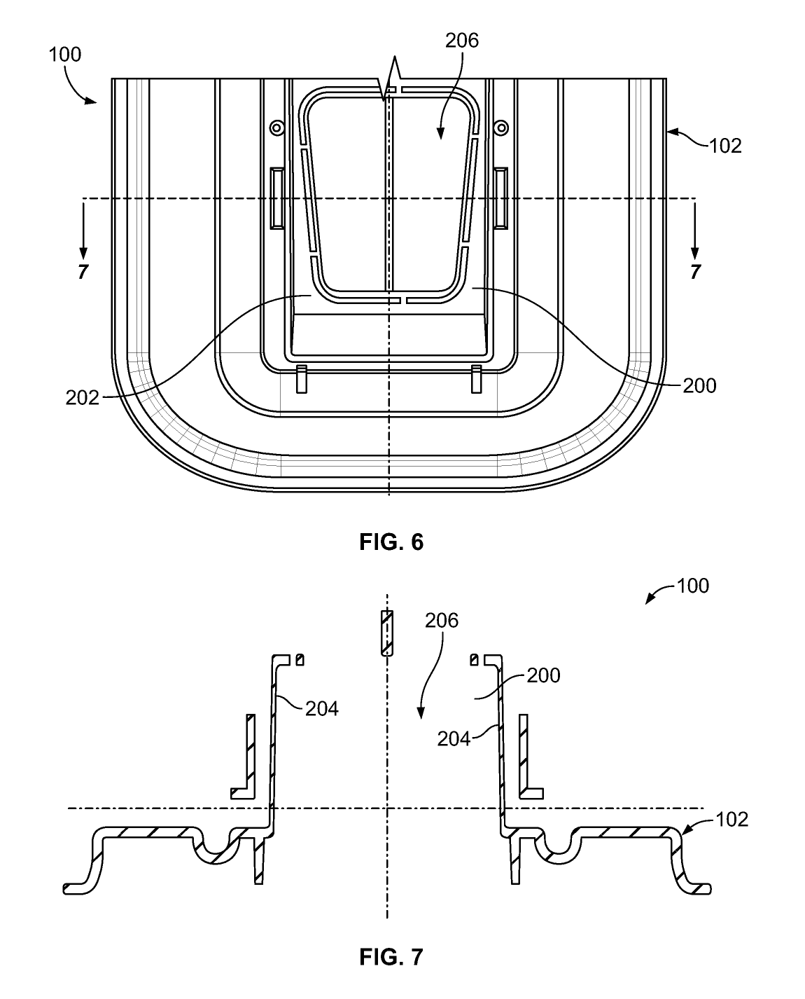

FIG. 6 illustrates a front view of a portion of a housing 102 of a pressure relief assembly 100, according to an embodiment of the present disclosure. FIG. 7 illustrates a cross-sectional view of the portion of the housing of the pressure relief assembly 100 through line 7-7 of FIG. 6. The portion of the housing 102 may be a portion of and/or proximate to a flap barrier 122, such as described above with respect to FIGS. 1-5.

Referring to FIGS. 1-7, in at least one embodiment, a retaining track 200 may be disposed proximate to (such as around) the flap openings 106. The retaining track 200 includes a base 202 and lateral walls 204 that define a retaining channel 206. The retaining track 200 is configured to receive and retain a noise-dampening material, such as polyurethane foam, which is configured to dampen noise that may be generated by flaps, as described above. As such, the retaining track 200 may be used in place of, or in addition to, the noise-dampening seals 120 shown and described with respect to FIGS. 1 and 2. For example, in at least one embodiment, the noise-dampening seals 120 shown in FIGS. 1 and 2 may be formed by retaining tracks 200 that retain a noise-dampening material, such as polyurethane foam. In at least one other embodiment, the noise-dampening seals 120 of FIGS. 1 and 2 and a separate retaining track 200 retaining a noise-dampening material proximate to the noise-dampening seals 120 may be used. In at least one embodiment, the retaining track 200 may be a contiguous track that retains a noise-dampening material. In at least one other embodiment, the retaining track 200 may define retaining portions separated by gaps, thereby defining a plurality of noise-dampening areas that retain a noise-dampening material.

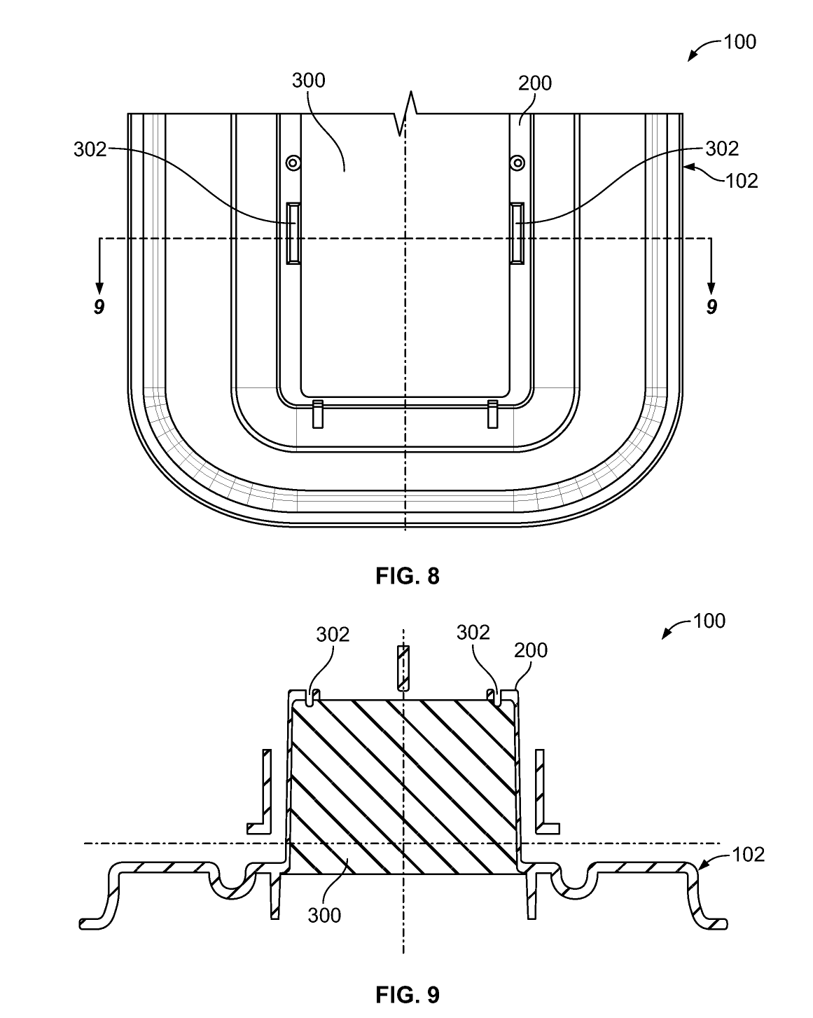

FIG. 8 illustrates a front view of a portion of the housing 102 of the pressure relief assembly 100 having a noise-dampening fixture 300, according to an embodiment of the present disclosure. FIG. 9 illustrates a cross-sectional view of the portion of the housing 102 of the pressure relief assembly 100 having the noise-dampening fixture 300 through line 9-9 of FIG. 8. Referring to FIGS. 8 and 9, the noise-dampening fixture 300 is retained with the retaining track 200. The noise-dampening fixture 300 is formed of a noise-dampening material, such as polyurethane foam. The polyurethane foam may be injected into the retaining track 200 through one or more ports 302 formed in the housing 102 on and/or proximate to the retaining track 200.

Referring to FIGS. 1-9, interfaces (for example, the flap barriers 122, the backing wall 158, and/or the like) between the membrane flaps 170 and the housing 102 of the pressure relief assembly 100 may be formed of and/or covered with a noise-dampening material (such as rubber, elastomeric materials, and the like that are softer than harder plastics typically used to form a housing of a pressure relief housing) that provides a sealing interface that prevents or otherwise reduces reverse air flow and water infiltration therethrough, while also dampening noise that may be generated by interaction of the membrane flaps 170 and the housing 102. Further, embodiments of the present disclosure provide pressure relief assemblies 100 that allow the flaps 170 to freely pivot, thereby maximizing air flow in an open position (in contrast to other known pressure relief valves that include hinges that limit airflow and slap close, thereby generating a noticeable noise).

As described herein, the pressure relief assembly 100 includes the housing 102 including at least one air passage chamber 104 having at least one flap barrier 122 surrounding at least one airflow passage 106. A membrane flap 170 is secured within the air passage chamber 104. The membrane flap 170 covers the airflow passage 106 in a closed position. A portion (such as an free, unanchored portion) of the membrane flap 170 moves off the airflow passage 106 into an open position. A noise-dampening seal 120 proximate to at least a portion of the flap barrier is configured to reduce noise generated by movement of the membrane flap 170 as the membrane flap 170 moves from the open position to the closed position. The noise-dampening seal 170 provides a sealing interface with the membrane flap 170 in the closed position.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

To the extent used in the appended claims, the terms “including” and “in which” are used as the plain-English equivalents of the respective terms “comprising” and “wherein.” Moreover, to the extent used in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Various features of the disclosure are set forth in the following claims.

1. A pressure relief assembly comprising:
a housing including an air passage chamber having a flap barrier surrounding at least one airflow passage;
a membrane flap secured within the air passage chamber, wherein the membrane flap covers the airflow passage in a closed position, and wherein a portion of the membrane flap is configured to move off the airflow passage into an open position; and
a noise-dampening seal formed of a noise-dampening material proximate to at least a portion of the flap barrier, wherein the noise-dampening seal is configured to reduce noise generated by movement of the membrane flap as the membrane flap moves from the open position to the closed position, and wherein the noise-dampening seal provides a sealing interface with the membrane flap in the closed position.

2. The pressure relief assembly of claim 1, wherein the housing is formed of a material that is harder than the noise-dampening material.

3. The pressure relief assembly of claim 1, wherein the housing is formed of a material that is harder than the noise-dampening material, and wherein at least a portion of the housing is covered with the noise-dampening material.

4. The pressure relief assembly of claim 1, wherein the housing is also formed of the noise-dampening material.

5. The pressure relief assembly of claim 1, wherein the noise-dampening seal is secured on and around the at least a portion of the flap barrier.

6. The pressure relief assembly of claim 1, wherein the noise-dampening seal is secured below and around lateral portions of the flap barrier.

7. The pressure relief assembly of claim 1, wherein the noise-dampening seal is secured on and around an entirety of the flap barrier.

8. The pressure relief assembly of claim 1, wherein the noise-dampening material comprises one or more of rubber, a thermoplastic elastomer, or a thermoplastic vulcanizate.

9. The pressure relief assembly of claim 1, wherein the housing and the noise-dampening seal are integrally molded and formed as a single piece of the noise-dampening material.

10. The pressure relief assembly of claim 1, wherein the housing further comprises upstanding ribs formed of the noise-dampening material.

11. The pressure relief assembly of claim 10, wherein the upstanding ribs extend outwardly from a top wall proximate to a pivot location of the membrane flap towards a front outer flange of the housing, wherein the ribs are configured to prevent the membrane flap from flapping into a backing wall and the outer flange of the housing.

12. The pressure relief assembly of claim 1, wherein the noise-dampening seal comprises the noise-dampening material within a retaining track proximate to the flap barrier.

13. The pressure relief assembly of claim 12, wherein the noise-dampening material comprises polyurethane foam.

14. The pressure relief assembly of claim 1, further comprises a retaining track that retains an additional noise-dampening material proximate to the flap barrier.

15. The pressure relief assembly of claim 14, wherein the additional noise-dampening material comprises polyurethane foam.

16. A pressure relief assembly comprising:
a housing including an air passage chamber having a flap barrier surrounding at least one airflow passage, wherein the housing further comprises upstanding ribs formed of the noise-dampening material, wherein the upstanding ribs extend outwardly from a top wall proximate to a pivot location towards a front outer flange of the housing;
a membrane flap secured within the air passage chamber, wherein the membrane flap covers the airflow passage in a closed position, and wherein a portion of the membrane flap is configured to move off the airflow passage into an open position; and
a noise-dampening seal formed of a noise-dampening material proximate to at least a portion of the flap barrier, wherein the noise-dampening seal is configured to reduce noise generated by movement of the membrane flap as the membrane flap moves from the open position to the closed position, wherein the noise-dampening seal provides a sealing interface with the membrane flap in the closed position, wherein the ribs are configured to prevent the membrane flap from flapping into a backing wall and the outer flange of the housing.

17. The pressure relief assembly of claim 16, wherein the housing is formed of a material that is harder than the noise-dampening material.

18. The pressure relief assembly of claim 16, wherein the housing is formed of a material that is harder than the noise-dampening material, and wherein at least a portion of the housing is covered with the noise-dampening material.

19. The pressure relief assembly of claim 16, wherein the housing is also formed of the noise-dampening material, wherein the housing and the noise-dampening seal are integrally molded and formed as a single piece of the noise-dampening material.

20. The pressure relief assembly of claim 16, wherein the noise-dampening seal is secured on and around the at least a portion of the flap barrier.
